(19) United States
(12) Patent Application Publication
(10) Pub. No.: US 2026/0302589 A1
(43) Pub. Date: Oct. 1, 2026

(54) ANTENNA DEVICE AND VEHICLE COMMUNICATION EQUIPMENT

(71) Applicant: AUO Corporation, Hsinchu City (TW)

(72) Inventors: Shih-Hsien Yang, Hsinchu City (TW); Chung-Hung Chen, Hsinchu City (TW); Yi-Cheng Lai, Hsinchu City (TW); Yu-Chih Wang, Hsinchu City (TW); Yi-Hui Lin, Hsinchu City (TW); Shuo-Yang Sun, Hsinchu City (TW); Hsiu-Yin Cheng, Hsinchu City (TW)

(73) Assignee: AUO Corporation, Hsinchu City (TW)

(21) Appl. No.: 19/356,197

(22) Filed: Oct. 13, 2025

(30) Foreign Application Priority Data
Mar. 31, 2025 (TW) 114112341

(51) Int. Cl. H01Q 1/12; H01Q 9/04; H01Q 21/06

(52) U.S. Cl. CPC H01Q 1/1271; H01Q 9/0414; H01Q 21/065

(57) ABSTRACT

An antenna device including a first transparent substrate, a second transparent substrate and multiple antenna units is provided. A gap exists between the first transparent substrate and the second transparent substrate. Each antenna unit includes a first antenna electrode, a second antenna electrode, a patterned wire layer, and a chip. Patterned wires of the patterned wire layer are couple to the second antenna electrode. The second antenna electrode is coupled to the first antenna electrode. The chip is bonded to the patterned wires. A thickness of the first transparent substrate and a thickness of the second transparent substrate are both less than 0.7 mm. A vehicle communication equipment is also provided.

### CROSS-REFERENCE TO RELATED APPLICATION

This application claims the priority benefit of Taiwan application serial no. 114112341, filed on Mar. 31, 2025. The entirety of the above-mentioned patent application is hereby incorporated by reference herein and made a part of this specification.

### BACKGROUND

### Technical Field

This disclosure relates to an antenna device and a vehicle communication equipment.

### Description of Related Art

In the prior art applied to satellite communication, antenna devices utilize the surfaces of two transparent substrates to set antenna electrodes. In order to obtain a bandwidth above 3.8 GHz, the thicknesses of the two transparent substrates must be different, and at least one of the transparent substrates has a thickness that does not belong to common specifications, which increases the process difficulty and manufacturing cost of the antenna device.

### SUMMARY

The disclosure provides an antenna device and a vehicle communication equipment with low process difficulty and manufacturing cost, and having good transmission performance.

According to an embodiment of the disclosure, an antenna device is provided, including a first transparent substrate, a second transparent substrate, and multiple antenna units. The first transparent substrate has a first surface and a second surface opposite to each other. The second transparent substrate has a third surface and a fourth surface opposite to each other. A gap exists between the first transparent substrate and the second transparent substrate. The antenna units are arranged in an array form, and each of the antenna units includes a first antenna electrode, a second antenna electrode, a patterned wire layer, and a chip. The first antenna electrode is disposed on the first surface of the first transparent substrate. The second antenna electrode is disposed on the third surface of the second transparent substrate. The patterned wire layer is disposed on the fourth surface of the second transparent substrate and includes patterned wires. The patterned wires are coupled to the second antenna electrode. The second antenna electrode is coupled to the first antenna electrode. The chip is bonded to the patterned wires on the fourth surface. A thickness of the first transparent substrate and a thickness of the second transparent substrate are both less than 0.7 mm.

According to an embodiment of the disclosure, a vehicle communication equipment is provided, including the antenna device. The antenna device is configured on a car window or sunroof.

Based on the above, in the antenna device provided according to embodiments of the disclosure, a gap is provided between two transparent substrates, whereby the thickness of the two transparent substrates may be reduced, and the thickness of the two transparent substrates may be substantially the same. Under the premise of significantly reducing process difficulty and cost, the antenna device and the vehicle communication equipment having the antenna device may provide satisfactory bandwidth.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A shows a plan schematic diagram of an antenna device according to some embodiments of the disclosure, and FIG. 1B shows a cross-sectional schematic diagram of the antenna device of FIG. 1A according to some embodiments of the disclosure.

FIG. 2A shows S parameter curves of an antenna device according to a first embodiment of the disclosure.

FIG. 2B shows S parameter curves of an antenna device according to a second embodiment of the disclosure.

FIG. 2C shows S parameter curves of antenna devices according to an embodiment of the disclosure and according to a comparative example by means of curve L1 and curve L2, respectively.

FIG. 3A shows S parameter curves of an antenna device according to a third embodiment of the disclosure.

FIG. 3B shows S parameter curves of an antenna device according to a fourth embodiment of the disclosure.

FIG. 4A shows a cross-sectional schematic diagram of an antenna device according to some embodiments of the disclosure, FIG. 4B shows S parameter curves of an antenna device according to a fifth embodiment of the disclosure, FIG. 4C shows S parameter curves of an antenna device according to a sixth embodiment of the disclosure, and FIG. 4D shows power gain curves of the antenna device according to the sixth embodiment of the disclosure.

FIG. 5A to FIG. 5C respectively show partial schematic diagrams of an antenna device according to an embodiment of the disclosure. FIG. 5D shows a schematic diagram of a transparent substrate and supports in FIG. 5A to FIG. 5C.

FIG. 6A to FIG. 6C respectively show partial schematic diagrams of an antenna device according to an embodiment of the disclosure.

### DESCRIPTION OF THE EMBODIMENTS

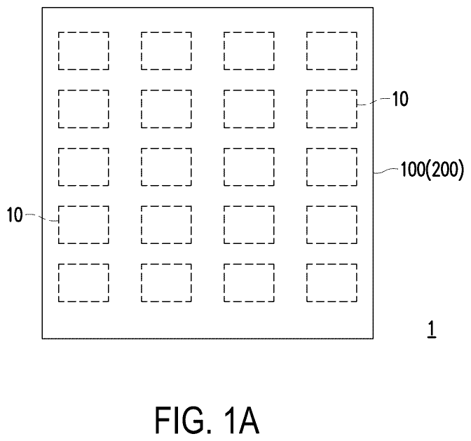

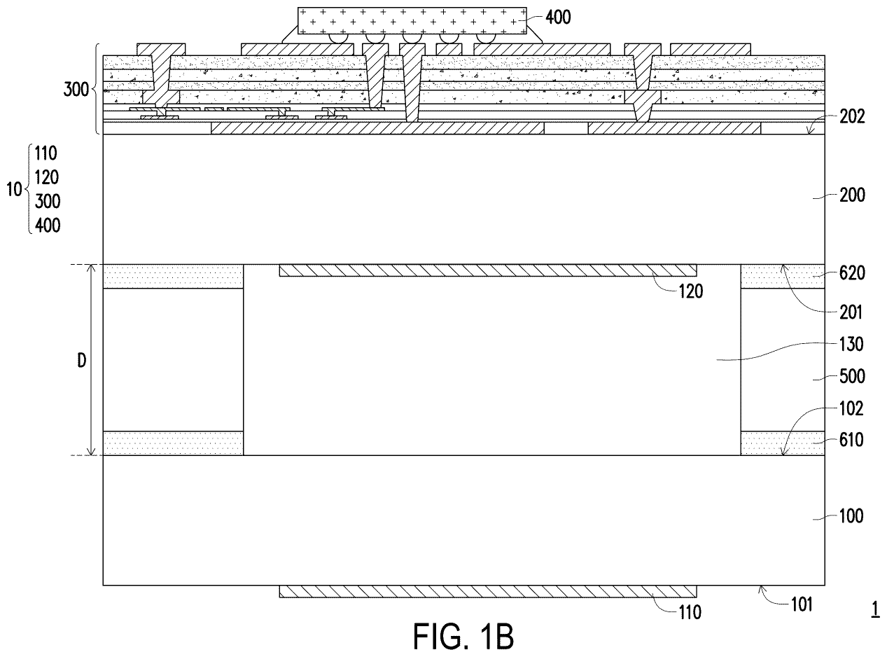

Referring to FIG. 1A and FIG. 1B, FIG. 1A shows a plan schematic diagram of an antenna device according to some embodiments of the disclosure, and FIG. 1B shows a cross-sectional schematic diagram of the antenna device of FIG. 1A according to some embodiments of the disclosure.

An antenna device 1 includes a transparent substrate 100, a transparent substrate 200, and multiple antenna units 10. The transparent substrate 100 and the transparent substrate 200 have high stiffness and may be, for example, transparent glass, but are not limited thereto. The transparent substrate 100 has opposing surfaces 101 and 102. The transparent substrate 200 has opposing surfaces 201 and 202. The surface 102 and the surface 201 are spaced apart by a distance D in the stacking direction of the transparent substrate 100 and the transparent substrate 200, and the distance D is greater than 0. A gap 130 exists between the transparent substrate 100 and the transparent substrate 200.

As shown in FIG. 1A, the antenna units 10 are arranged in an array form. Moreover, as shown in FIG. 1B, each antenna unit 10 includes an antenna electrode 110, an antenna electrode 120, a patterned wire layer 300, and a chip 400. The antenna electrode 110 may be disposed on the surface 101 of the transparent substrate 100 by means of electroplating or photolithography process. The antenna electrode 120 may be disposed on the surface 201 of the transparent substrate 200 by means of electroplating or photolithography process.

It should be understood that the arrangement method of the antenna units 10 in the antenna device 1 is not limited to the mutually aligned method shown in FIG. 1A. In some embodiments, the antenna units 10 in the antenna device 1 are misaligned with each other. In other words, the antenna device 1 provided according to embodiments of the disclosure has multiple antenna electrodes 110 on the surface 101 of the transparent substrate 100, and multiple antenna electrodes 120 on the surface 201 of the transparent substrate 200, and the antenna electrodes 110 and 120 may be mutually aligned or misaligned with each other. Moreover, each antenna electrode 110 and 120 may be of any shape, for example, rectangular, circular, polygonal, etc.

The patterned wire layer 300 is disposed on the surface 202 of the transparent substrate 200 and includes patterned wires. The patterned wires couple the antenna electrode 120, and the antenna electrode 120 couples the antenna electrode 110. The chip 400 may be, for example, a Beamformer Integrated Circuit (BFIC) or other active/passive elements, but is not limited thereto. The chip 400 joins the patterned wires of the patterned wire layer 300 on the surface 202. The thickness of the transparent substrate 100 and the thickness of the transparent substrate 200 are both less than 0.7 mm.

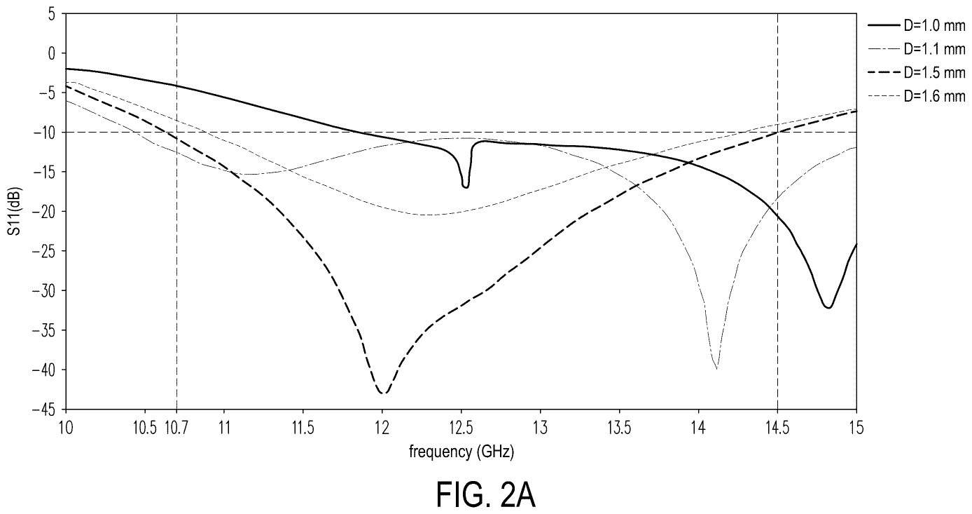

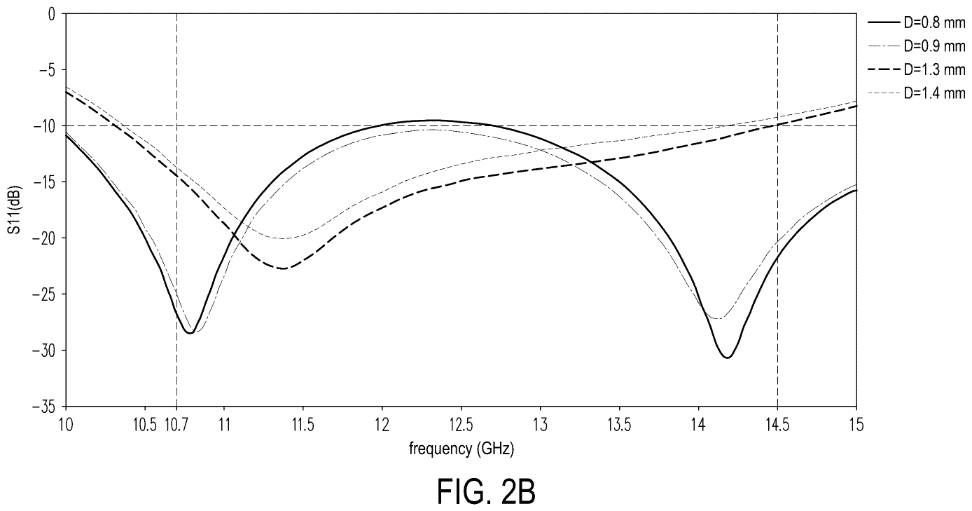

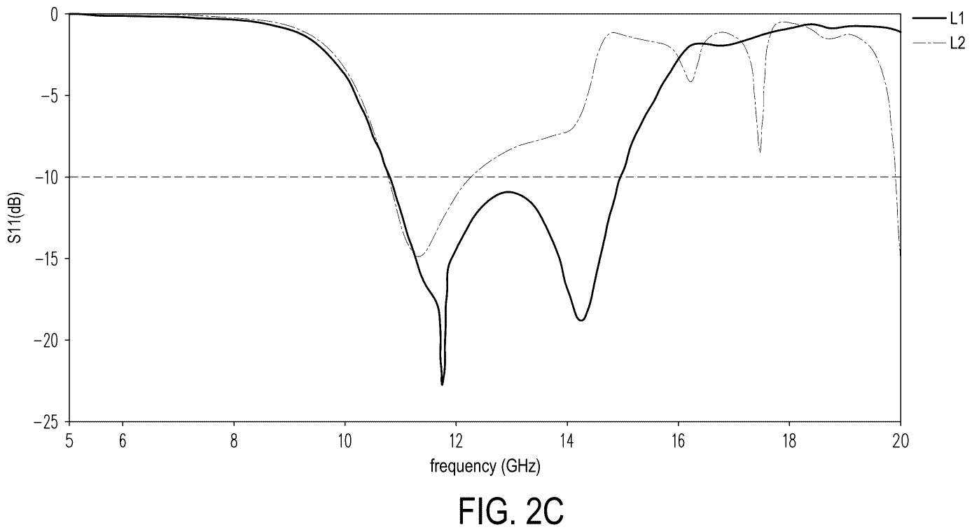

Referring to FIG. 1A, FIG. 1B, and FIG. 2A, FIG. 2A shows S parameter curves of an antenna device according to a first embodiment of the disclosure.

In the first embodiment, the transparent substrate 100 and the transparent substrate 200 of the antenna device 1 have the same thickness of 0.3 mm. When the distance D between the surface 102 and the surface 201 is 1.1 mm and 1.5 mm respectively, the return loss of the antenna device 1 in the frequency range of 10.7 GHz to 14.5 GHz (i.e., bandwidth 3.8 GHz) overlapping with the radio wave Ku frequency band may be greater than or equal to 10 dB. In contrast, as also shown in FIG. 2A, when the distance D between the surface 102 and the surface 201 is 1.0 mm and 1.6 mm respectively, the bandwidth of the antenna device 1 having return loss greater than or equal to 10 dB in the Ku frequency band will be less than 3.8 GHz. In other words, when the distance between the surface 101 and the surface 201 of the antenna device 1 falls in the range of 1.4 mm to 1.8 mm, the antenna device 1 may have at least bandwidth 3.8 GHz in the Ku frequency band.

Referring to FIG. 1A, FIG. 1B, and FIG. 2B, FIG. 2B shows S parameter curves of an antenna device according to a second embodiment of the disclosure.

In the second embodiment, the transparent substrate 100 and the transparent substrate 200 of the antenna device 1 have the same thickness of 0.5 mm. When the distance D between the surface 102 and the surface 201 is 0.9 mm and 1.3 mm respectively, the return loss of the antenna device 1 in the frequency range of 10.7 GHz to 14.5 GHz (i.e., bandwidth 3.8 GHz) overlapping with the radio wave Ku frequency band may be greater than or equal to 10 dB. In contrast, as also shown in FIG. 2B, when the distance D between the surface 102 and the surface 201 is 0.8 mm and 1.4 mm respectively, the bandwidth of the antenna device 1 having return loss greater than or equal to 10 dB in the Ku frequency band will be less than 3.8 GHz. In other words, when the distance between the surface 101 and the surface 201 of the antenna device 1 falls in the range of 1.4 mm to 1.8 mm, the antenna device 1 may have at least bandwidth 3.8 GHz in the Ku frequency band.

Referring to FIG. 1A, FIG. 1B, and FIG. 2C, FIG. 2C shows S parameter curves of antenna devices according to an embodiment of the disclosure and according to a comparative example by means of curve L1 and curve L2, respectively.

A curve L1 in FIG. 2C shows the S parameter curve of the antenna device 1 according to an embodiment of the disclosure. The transparent substrate 100 and the transparent substrate 200 of the antenna device 1 have the same thickness of 0.5 mm, and the distance D between the surface 102 and the surface 201 is 1.0 mm. A curve L2 in FIG. 2C shows the S parameter curve of the antenna device according to a comparative example. The transparent substrate 100 and the transparent substrate 200 of the antenna device 1 have the same thickness of 0.7 mm, and the distance D between the surface 102 and the surface 201 is 1.0 mm. It may be seen that the antenna device 1 according to the embodiment of the disclosure has a bandwidth of 4.19 GHz with return loss greater than or equal to 10 dB, which is much greater than the bandwidth of 1.52 GHz of the antenna device 1 according to the comparative example. In other words, when the thickness of both the transparent substrate 100 and the transparent substrate 200 is less than 0.7 mm, a larger bandwidth may be obtained.

It should be explained that, in another comparative example, when the distance D between the surface 102 and the surface 201 of the antenna device 1 is 0 mm (i.e., no gap 130 exists between the transparent substrate 100 and the transparent substrate 200), and the thickness of the transparent substrate 200 is 0.5 mm, the thickness of the transparent substrate 100 needs to reach 1.4 mm to enable the antenna device 1 to achieve a bandwidth of 3.8 GHz in the Ku frequency band. In contrast, the antenna device 1 provided according to the first embodiment and the second embodiment of the disclosure has a gap 130 configured between the transparent substrate 100 and the transparent substrate 200, enabling the antenna device 1 to have a bandwidth of at least 3.8 GHz under the condition that the thickness of both the transparent substrate 100 and the transparent substrate 200 is less than 0.7 mm.

In the first embodiment and second embodiment, the transparent substrate 100 and the transparent substrate 200 are both configured to have the same thickness. Specifically, by means of configuring the gap 130 between the transparent substrate 100 and the transparent substrate 200, the thickness of the transparent substrate 100 and the transparent substrate 200 does not need to be different, and the antenna device 1 may have a large bandwidth. In other words, the transparent substrate 100 and the transparent substrate 200 may be manufactured by the same process, greatly reducing process difficulty and cost.

It should be understood that the thickness of the transparent substrate 100 and the transparent substrate 200 is not limited to being completely equal. In some embodiments, the ratio of the thickness difference between the transparent substrate 100 and the transparent substrate 200 to the thickness of the transparent substrate 100 may be less than or equal to 0.1.

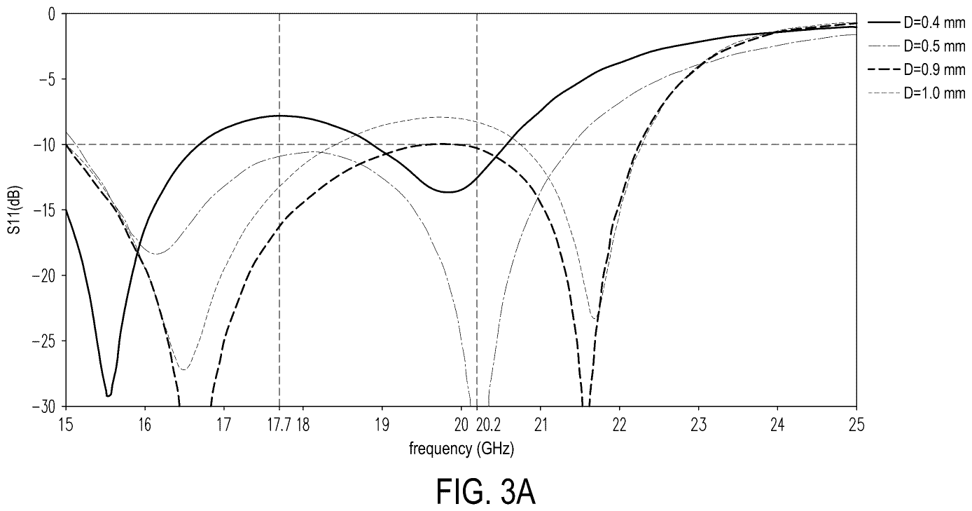

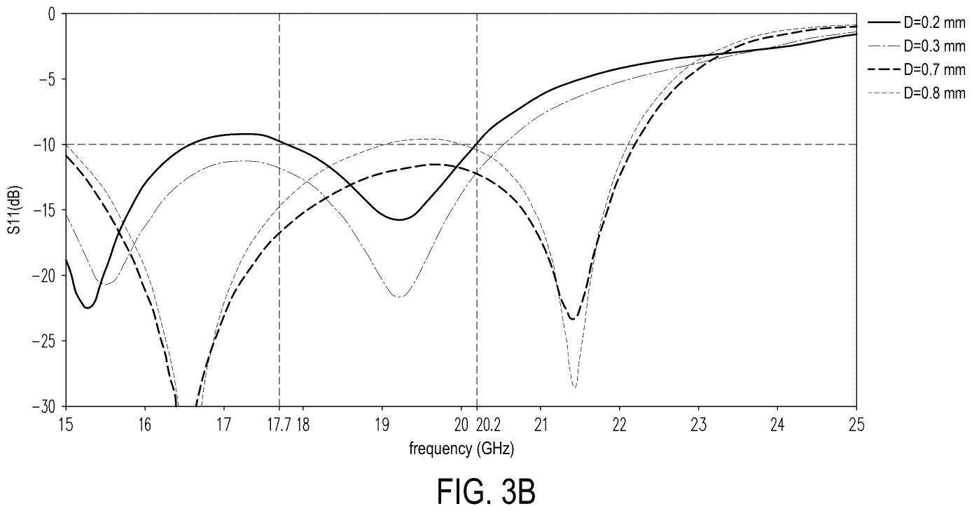

Referring to FIG. 1A, FIG. 1B and FIG. 3A, FIG. 3A shows S parameter curves of an antenna device according to a third embodiment of the disclosure.

In the third embodiment, the transparent substrate 100 and the transparent substrate 200 of the antenna device 1 have the same thickness of 0.3 mm. When the distance D between the surface 102 and the surface 201 is 0.5 mm and 0.9 mm respectively, the return loss of the antenna device 1 in the frequency range of 17.7 GHz to 20.2 GHz (i.e., bandwidth 2.5 GHz) overlapping with the radio wave K frequency band may be greater than or equal to 10 dB. In contrast, as also shown in FIG. 3A, when the distance D between the surface 102 and the surface 201 is 0.4 mm and 1.0 mm respectively, the bandwidth of the antenna device 1 having return loss greater than or equal to 10 dB in the K frequency band will be less than 2.5 GHz. In other words, when the distance between the surface 101 and the surface 201 of the antenna device 1 falls in the range of 0.8 mm to 1.2 mm, the antenna device 1 may have at least a bandwidth of 2.5 GHz in the K frequency band.

Referring to FIG. 1A, FIG. 1B and FIG. 3B, FIG. 3B shows S parameter curves of an antenna device according to a fourth embodiment of the disclosure.

In the fourth embodiment, the transparent substrate 100 and the transparent substrate 200 of the antenna device 1 have the same thickness of 0.5 mm. When the distance D between the surface 102 and the surface 201 is 0.3 mm and 0.7 mm respectively, the return loss of the antenna device 1 in the frequency range of 17.7 GHz to 20.2 GHz (i.e., bandwidth 2.5 GHz) overlapping with the radio wave K frequency band may be greater than or equal to 10 dB. In contrast, as also shown in FIG. 3B, when the distance D between the surface 102 and the surface 201 is 0.2 mm and 0.8 mm respectively, the bandwidth of the antenna device 1 having return loss greater than or equal to 10 dB in the K frequency band will be less than 2.5 GHz. In other words, when the distance between the surface 101 and the surface 201 of the antenna device 1 falls in the range of 0.8 mm to 1.2 mm, the antenna device 1 may have at least a bandwidth of 2.5 GHz in the K frequency band.

Referring to FIG. 1A and FIG. 1B, the antenna device 1 may further include multiple supports 500, an adhesive layer 610, and an adhesive layer 620. The supports 500 may include, for example, high transparent materials such as polystyrene (PS), polycarbonate (PC), polymethyl methacrylate, acrylic (PMMA), and photosensitive polyimide (PSPI). In some preferred embodiments, the supports 500, the adhesive layer 610, and the adhesive layer 620 have a transmittance greater than 88% for visible light, thereby making the antenna device 1 suitable for being configured on a car window or sunroof. The antenna device 1 forms a gap 130 by means of the supports 500. The adhesive layer 610 is configured between each support 500 and the transparent substrate 100, and the adhesive layer 620 is configured between each support 500 and the transparent substrate 200. The materials of the adhesive layer 610 and the adhesive layer 620 may be the same, and may be disposed by means of, for example, photolithography process, stamping, or dispensing process.

It should also be explained that the supports 500 may be configured between the antenna units 10 shown in FIG. 1A, but the disclosure is not limited thereto. In some embodiments, two adjacent antenna units 10 may correspond to the connected gap 130, and the supports 500 may not be configured therebetween. In some embodiments, the number of the antenna units 10 corresponding to the connected gap 130 may be greater than or equal to 2.

In some embodiments, openings may be formed in each support 500, and the shape, size, and position of the openings are not limited, thereby enabling air circulation within the gap 130 to avoid deformation of the transparent substrates 100 and 200 caused by temperature rise, which would reduce the bandwidth of the antenna device 1. However, the disclosure is not limited thereto, and in some embodiments, the gap 130 is a vacuum.

In order to fully explain various implementation aspects of the disclosure, other embodiments of the disclosure will be described below. It must be explained here that the following embodiments use the reference numerals and partial content of the aforementioned embodiments, wherein the same reference numerals are used to represent the same or similar elements, and the explanation of the same technical content is omitted. For the explanation of the omitted parts, reference may be made to the aforementioned embodiments, and the following embodiments will not repeat the description.

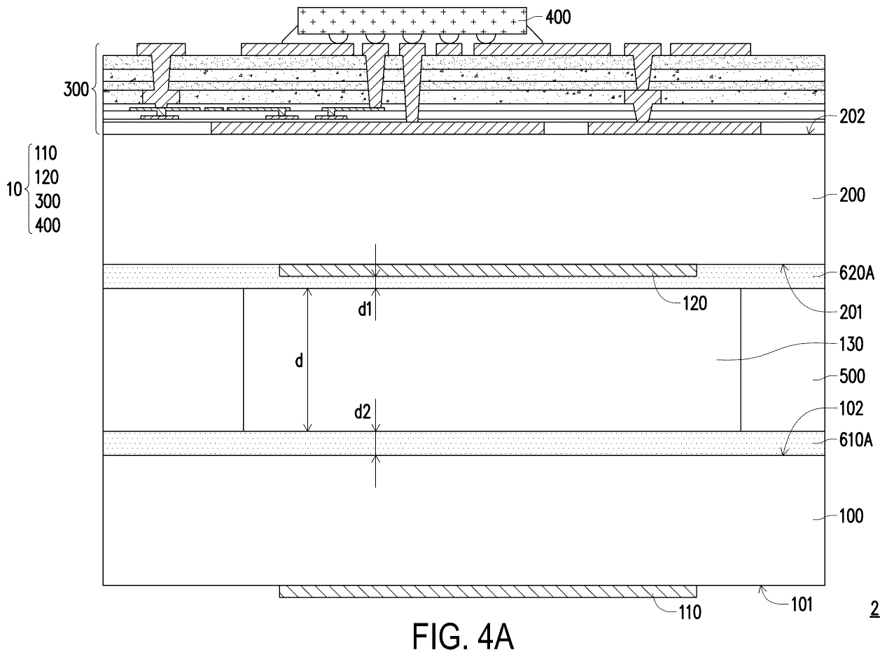

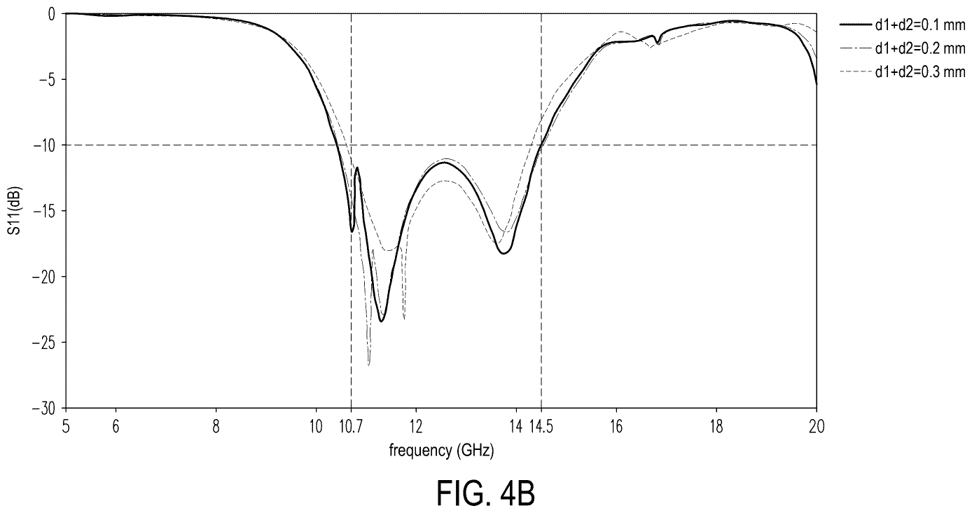

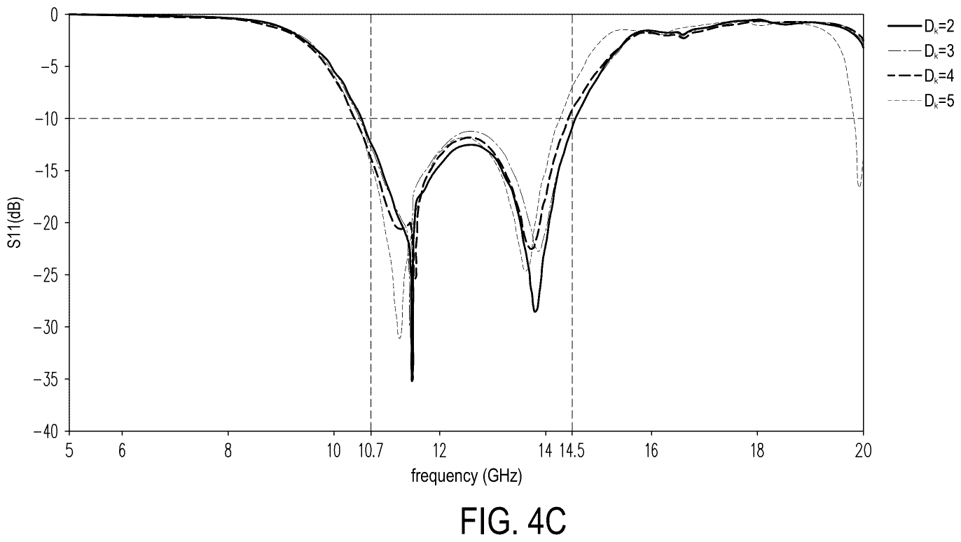

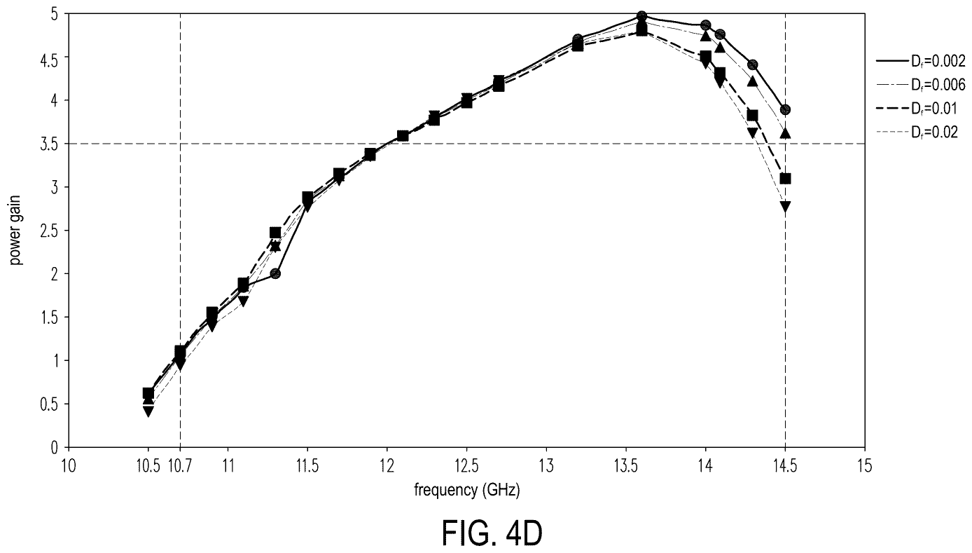

Referring to FIG. 4A to FIG. 4D, FIG. 4A shows a cross-sectional schematic diagram of an antenna device according to some embodiments of the disclosure, FIG. 4B shows S parameter curves of an antenna device according to a fifth embodiment of the disclosure, FIG. 4C shows S parameter curves of an antenna device according to a sixth embodiment of the disclosure, and FIG. 4D shows power gain curves of the antenna device according to the sixth embodiment of the disclosure.

Referring to FIG. 4A first, an antenna device 2 includes a transparent substrate 100, a transparent substrate 200, an antenna unit 10, multiple supports 500, an adhesive layer 610A, and an adhesive layer 620A. The adhesive layer 610A and adhesive layer 620A of the antenna device 2 correspond to the supports 500, and are further disposed between the antenna electrode 110 and the antenna electrode 120.

Referring to FIG. 4A and FIG. 4B, according to the fifth embodiment of the disclosure, the transparent substrate 100 and transparent substrate 200 of the antenna device 2 have the same thickness of 0.5 mm. When a distance d between the adhesive layer 610A and adhesive layer 620A between the antenna electrode 110 and antenna electrode 120 is 1.1 mm, and the total thickness of both (i.e., the sum of a thickness d1 and a thickness d2) is 0.1 mm and 0.2 mm respectively, the return loss of the antenna device 2 in the frequency range of 10.7 GHz to 14.5 GHz (i.e., bandwidth 3.8 GHz) overlapping with the radio wave Ku frequency band may be greater than or equal to 10 dB. In contrast, as also shown in FIG. 4B, when d is 1.1 mm and the sum of the thickness d1 and the thickness d2 is 0.3 mm, the bandwidth of the antenna device 2 having return loss greater than or equal to 10 dB in the Ku frequency band will be less than 3.8 GHz. Specifically, when the ratio of the sum of the thickness d1 and the thickness d2 to the distance d is less than or equal to 0.18, the antenna device 2 may have at least a bandwidth of 3.8 GHz in the Ku frequency band.

Referring to FIG. 4A, FIG. 4C, and FIG. 4D, according to the sixth embodiment of the disclosure, when the dielectric constants (Dₖ) of the adhesive layer 610A and adhesive layer 620A are 2, 3, and 4 respectively, the return loss of the antenna device 2 in the frequency range of 10.7 GHz to 14.5 GHz (i.e., bandwidth 3.8 GHz) overlapping with the radio wave Ku frequency band may be greater than or equal to 10 dB. In contrast, when the dielectric constant (Dₖ) of the adhesive layer 610A and adhesive layer 620A is 5, the bandwidth of the antenna device 2 having return loss greater than or equal to 10 dB in the Ku frequency band will be less than 3.8 GHz. Specifically, when the dielectric constants (Dₖ) of the adhesive layer 610A and adhesive layer 620A are less than or equal to 4, the antenna device 2 may have at least a bandwidth of 3.8 GHz in the Ku frequency band. Preferably, to avoid significant reduction of power gain at high frequencies, the dielectric loss (D_{f}) of the adhesive layer 610A and adhesive layer 620A is preferably less than or equal to 0.006, as shown in FIG. 4D.

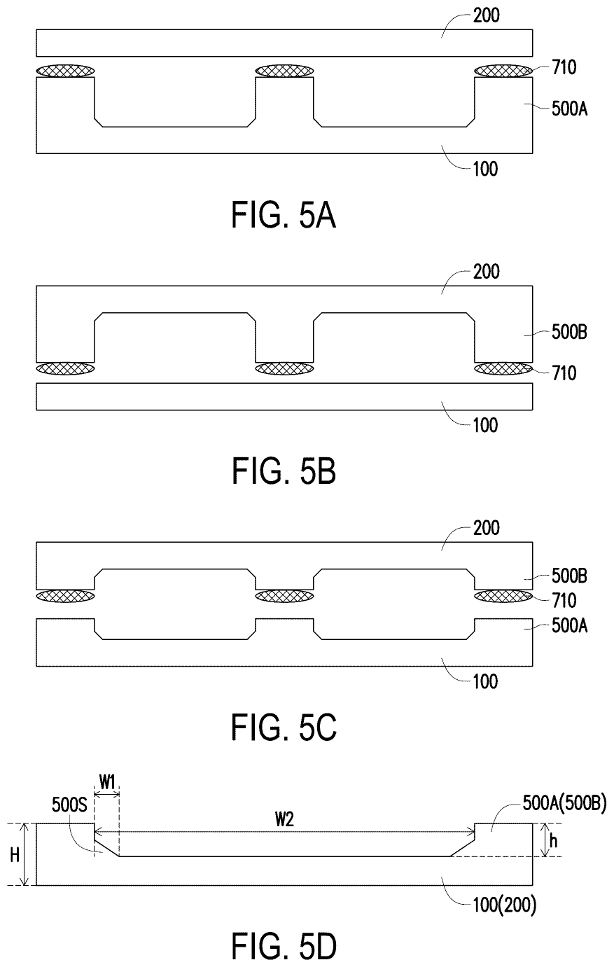

Referring to FIG. 5A to FIG. 5D, FIG. 5A to FIG. 5C respectively show partial schematic diagrams of an antenna device according to an embodiment of the disclosure, and FIG. 5D shows a schematic diagram of a transparent substrate and supports in FIG. 5A to FIG. 5C.

As shown in FIG. 5A, the supports 500A may be disposed by integral molding with the transparent substrate 100. In this embodiment, only one adhesive layer 710 is needed to form the gap between the transparent substrate 100 and the transparent substrate 200, thereby avoiding excessive adhesive layers that cause bandwidth reduction of the antenna device.

As shown in FIG. 5B, the supports 500B may be disposed by integral molding with the transparent substrate 200. In this embodiment, only one adhesive layer 710 is needed to form the gap between the transparent substrate 100 and the transparent substrate 200, thereby avoiding excessive adhesive layers that cause bandwidth reduction of the antenna device.

As shown in FIG. 5C, the supports 500A may be disposed by integral molding with the transparent substrate 100, and the supports 500B may be disposed by integral molding with the transparent substrate 200. In this embodiment, only one adhesive layer 710 is needed to form the gap between the transparent substrate 100 and the transparent substrate 200, thereby avoiding excessive adhesive layers that cause bandwidth reduction of the antenna device.

According to some embodiments, as shown in FIG. 5D, a support 500A (or support 500B) has a height h, and the support 500A (or support 500B) together with the transparent substrate 100 (or transparent substrate 200) has a height H. The ratio of the height h to the height H may fall in the range of 0.1 to 0.5, but is not limited thereto. Moreover, the support 500A (or support 500B) includes a slope portion 500S having a width W1, and the ratio of the width W1 to a distance W2 between two adjacent supports 500A (or two supports 500B) may be greater than 0 and less than or equal to 0.05, but is not limited thereto.

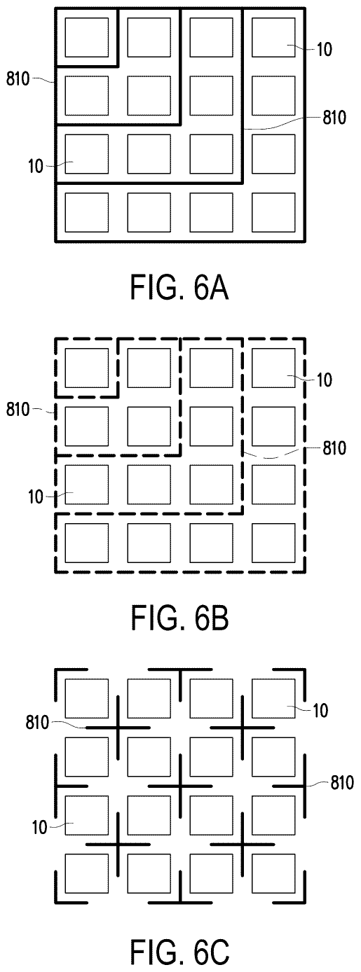

FIG. 6A to FIG. 6C respectively show partial schematic diagrams of an antenna device according to an embodiment of the disclosure.

As shown in FIG. 6A, the antenna units 10 are arranged in an array form. Adjacent antenna units 10 may be separated by an adhesive layer 810 and supports (not shown) corresponding to the adhesive layer 810, wherein the adhesive layer 810 is continuously configured. Alternatively, there may be no adhesive layer 810 and supports between the adjacent antenna units 10, and correspond to the connected gap (not shown). Compared to the structure shown in FIG. 6A, FIG. 6B shows discontinuously configured adhesive layer 810. Accordingly, the usage of the adhesive may be reduced, avoiding bandwidth reduction of the antenna device.

The arrangement method of the adhesive layer 810 and the supports corresponding to the adhesive layer 810 is not limited to the L-shaped arrangement shown in FIG. 6A and FIG. 6B. Referring to FIG. 6C, the arrangement method of the adhesive layer 810 and the supports corresponding to the adhesive layer 810 may be cross-shaped arrangement, T-shaped arrangement, and L-shaped arrangement. In other embodiments not shown, different supports may be separated from each other without being arranged in the above-mentioned methods.

It should be explained that the antenna device provided according to any of the above embodiments may be configured in a vehicle communication equipment. The antenna device may be configured on car windows, on sunroofs, and outside the vehicle body, but is not limited thereto. In some embodiments, the antenna device may be configured on ships or aircraft.

In summary, in the antenna device provided according to embodiments of the disclosure, a gap is provided between two transparent substrates, whereby the thickness of the two transparent substrates may be reduced, and the thickness of the two transparent substrates may be substantially the same. Under the premise of significantly reducing process difficulty and cost, the antenna device and the vehicle communication equipment having the antenna device may provide satisfactory bandwidth.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An antenna device, comprising:
a first transparent substrate, having a first surface and a second surface opposite to each other;
a second transparent substrate, having a third surface and a fourth surface opposite to each other, wherein a gap exists between the first transparent substrate and the second transparent substrate; and
a plurality of antenna units, arranged in an array form, and each of the antenna units comprises:
a first antenna electrode, disposed on the first surface of the first transparent substrate;
a second antenna electrode, disposed on the third surface of the second transparent substrate;
a patterned wire layer, disposed on the fourth surface of the second transparent substrate and comprising patterned wires, the patterned wires coupled to the second antenna electrode, the second antenna electrode coupled to the first antenna electrode; and
a chip, bonded to the patterned wires on the fourth surface,
wherein a thickness of the first transparent substrate and a thickness of the second transparent substrate are both less than 0.7 mm.

2. The antenna device according to claim 1, wherein a ratio of a thickness difference between the first transparent substrate and the second transparent substrate to the thickness of the first transparent substrate is less than or equal to 0.1.

3. The antenna device according to claim 1, wherein a distance between the first surface and the third surface falls within a range of 1.4 mm to 1.8 mm.

4. The antenna device according to claim 1, wherein a distance between the first surface and the third surface falls within a range of 0.8 mm to 1.2 mm.

5. The antenna device according to claim 3, further comprising a plurality of supports, a first adhesive layer, and a second adhesive layer, wherein the antenna device forms the gap by means of the supports, the first adhesive layer is configured between each of the supports and the first transparent substrate, the second adhesive layer is configured between the each of the supports and the second transparent substrate, and the first adhesive layer and the second adhesive layer have the same material.

6. The antenna device according to claim 5, wherein the first adhesive layer and the second adhesive layer are further disposed between the first antenna electrode and the second antenna electrode.

7. The antenna device according to claim 6, wherein the first adhesive layer and the second adhesive layer have a dielectric constant (Dₖ) less than or equal to 4, and a dielectric loss (D_{f}) less than or equal to 0.006.

8. The antenna device according to claim 6, wherein a distance is between the first adhesive layer and the second adhesive layer, the first adhesive layer and the second adhesive layer between the first antenna electrode and the second antenna electrode have a total thickness, and a ratio between the total thickness and the distance is less than or equal to 0.18.

9. The antenna device according to claim 4, further comprising a plurality of supports, a first adhesive layer, and a second adhesive layer, wherein the antenna device forms the gap by means of the supports, the first adhesive layer is configured between each of the supports and the first transparent substrate, the second adhesive layer is configured between the each of the supports and the second transparent substrate, and the first adhesive layer and the second adhesive layer have the same material.

10. The antenna device according to claim 9, wherein the first adhesive layer and the second adhesive layer are further disposed between the first antenna electrode and the second antenna electrode.

11. The antenna device according to claim 10, wherein the first adhesive layer and the second adhesive layer have a dielectric constant (Dₖ) less than or equal to 4, and a dielectric loss (D_{f}) less than or equal to 0.006.

12. The antenna device according to claim 10, wherein a distance is between the first adhesive layer and the second adhesive layer, the first adhesive layer and the second adhesive layer between the first antenna electrode and the second antenna electrode have a total thickness, and a ratio between the total thickness and the distance is less than or equal to 0.18.

13. The antenna device according to claim 3, further comprising a plurality of supports, wherein the antenna device forms the gap by means of the supports, and the supports are disposed by integral molding with at least one of the first transparent substrate and the second transparent substrate.

14. The antenna device according to claim 13, wherein only one adhesive layer is configured between the first transparent substrate and the second transparent substrate.

15. The antenna device according to claim 4, further comprising a plurality of supports, wherein the antenna device forms the gap by means of the supports, and the supports are disposed by integral molding with at least one of the first transparent substrate and the second transparent substrate.

16. The antenna device according to claim 15, wherein only one adhesive layer is configured between the first transparent substrate and the second transparent substrate.

17. A vehicle communication equipment, comprising an antenna device configured on a car window or sunroof, wherein the antenna device comprises:
a first transparent substrate, having a first surface and a second surface opposite to each other;
a second transparent substrate, having a third surface and a fourth surface opposite to each other, wherein a gap exists between the first transparent substrate and the second transparent substrate; and
a plurality of antenna units, arranged in an array form, and each of the antenna units comprises:
a first antenna electrode, disposed on the first surface of the first transparent substrate;
a second antenna electrode, disposed on the third surface of the second transparent substrate;
a patterned wire layer, disposed on the fourth surface of the second transparent substrate and comprising patterned wires, the patterned wires coupled to the second antenna electrode, the second antenna electrode coupled to the first antenna electrode; and
a chip, bonded to the patterned wires on the fourth surface,
wherein a thickness of the first transparent substrate and a thickness of the second transparent substrate are both less than 0.7 mm.
